(19) United States
(12) Patent Application Publication
(10) Pub. No.: US 2013/0322364 A1
(43) Pub. Date: Dec. 5, 2013

(54) METHOD AND MOBILE COMMUNICATIONS DEVICE UTILIZING THE SAME

(71) Applicant: MediaTek Inc., Hsin-Chu (TW)

(72) Inventor: Jeng-Yi TSAI, Hsinchu City (TW)

(73) Assignee: MediaTek Inc., Hsin-Chu (TW)

(21) Appl. No.: 13/896,636

(22) Filed: May 17, 2013

Related U.S. Application Data
(60) Provisional application No. 61/653,590, filed on May 31, 2012.

(51) Int. Cl. H04W 52/24

(52) U.S. Cl. CPC H04W 52/24
USPC 370/329

(57) ABSTRACT

Embodiments of a method and a mobile communications device utilizing the same are provided. The method is implemented in a mobile communications device, including retrieving a first data from a TPC field of a slot of a radio frame from a downlink dedicated physical channel (DL DPCH), decoding an uplink TPC command based on the first data, and estimating a signal quality based on the first data.

### CROSS REFERENCE TO RELATED APPLICATIONS

This Application claims priority of U.S. Provisional Application No. 61/653,590, filed on May 31, 2012, and the entirety of which is incorporated by reference herein.

### BACKGROUND OF THE INVENTION

1. Field of the Invention

The present invention relates to a Universal Mobile Telecommunications System Frequency-Division Duplexing (UMTS FDD) communications system, and in particular, relates to a power control method and a mobile communications device utilizing the same in the UMTS FDD communications system.

2. Description of the Related Art

Power control is a critical function in UMTS FDD based systems. It is also a function that couples the system level performance with the radio link level performance. As a consequence, the minimization of the transmit powers results in reduced interference, which in turn translates into increased system capacity.

### BRIEF SUMMARY OF THE INVENTION

A detailed description is given in the following embodiments with reference to the accompanying drawings.

An embodiment of a method implemented in a mobile communications device is described, comprising: retrieving a first data from a TPC field of a slot of a radio frame from a downlink dedicated physical channel (DL DPCH); decode a uplink TPC command on the first data; and estimating a signal quality based on the first data.

Another embodiment of a mobile communications device is provided, comprising a receiver and a controller. The receiver is configured to receive a radio frame from a DL DPCH. The controller, coupled to the receiver, is configured to retrieve a first data from a TPC field of a slot of the radio frame, decode a uplink TPC command on the first data, and estimate a signal quality based on the first data

### BRIEF DESCRIPTION OF THE DROWINGS

The present invention can be more fully understood by reading the subsequent detailed description and examples with references made to the accompanying drawings, wherein:

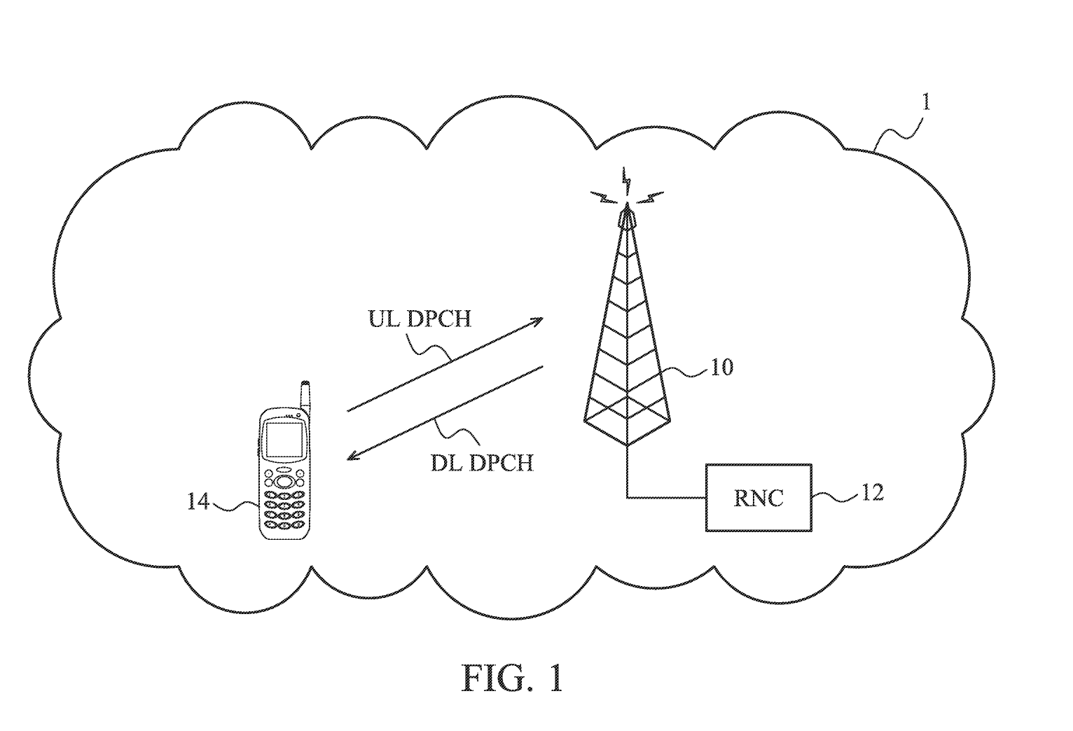

FIG. 1 is a system diagram of a UTRAN according to an embodiment of the invention.

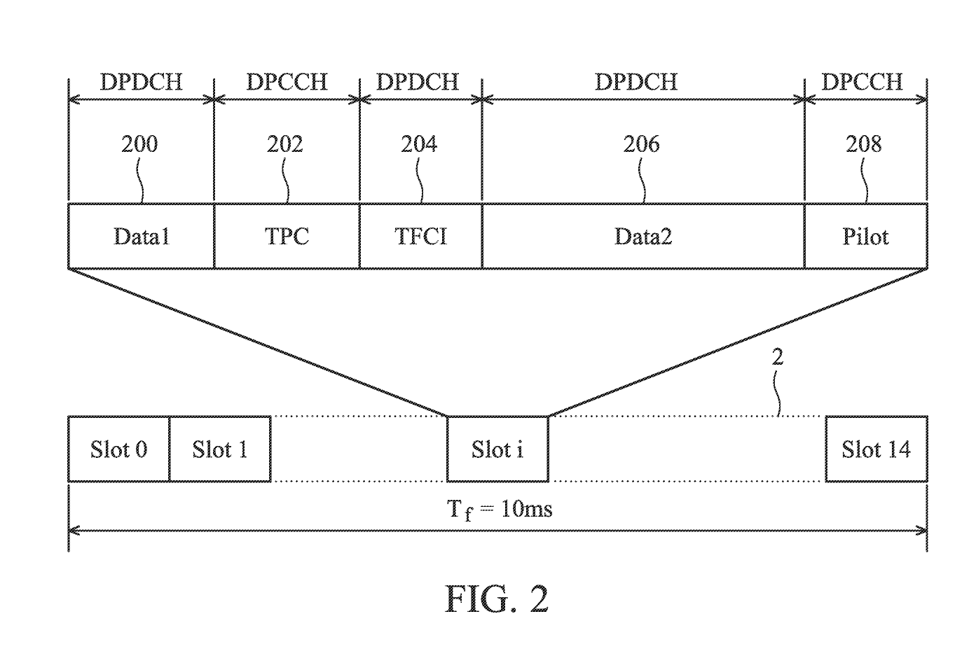

FIG. 2 shows a radio frame on the DL DPCH.

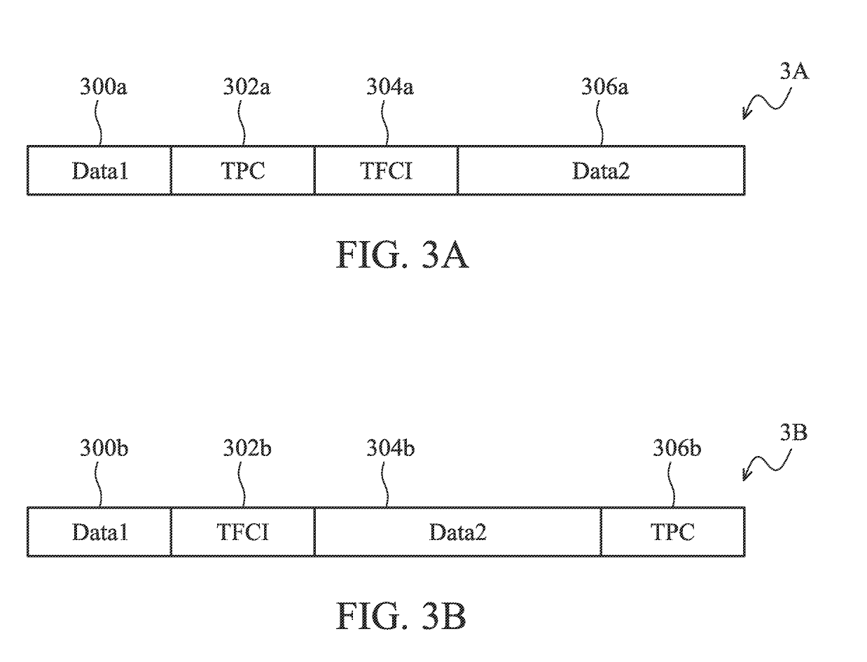

FIGS. 3A and 3B illustrate slot formats of a radio frame on the DL DPCH according to embodiments of the invention.

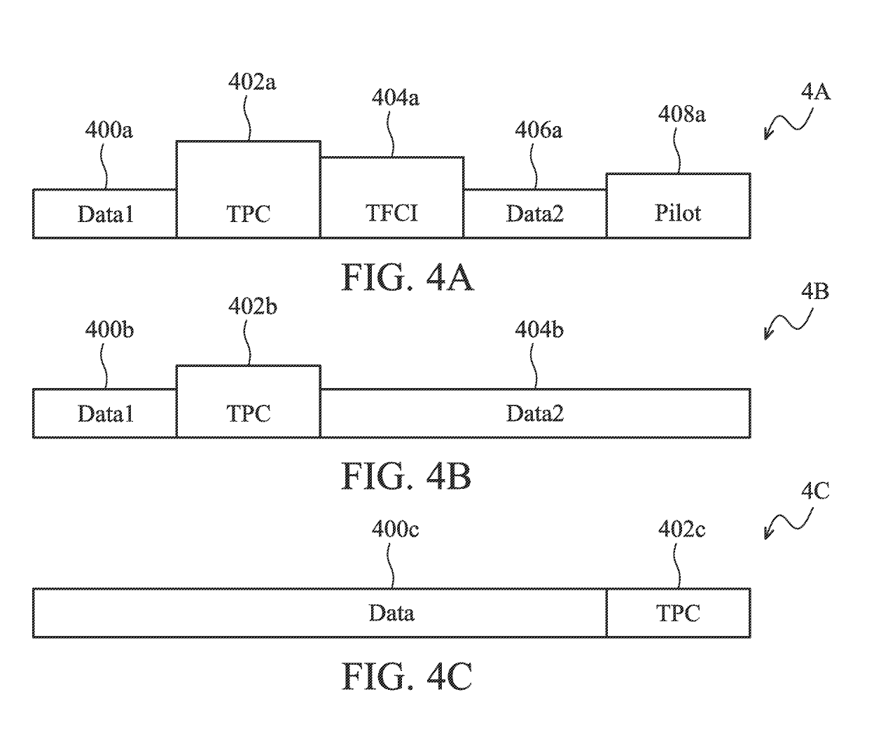

FIG. 4A shows a power configuration for a slot of a radio frame on the DL DPCH.

FIGS. 4B and 4C illustrate power configurations for slots of a radio frame on the DL DPCH according to embodiments of the invention.

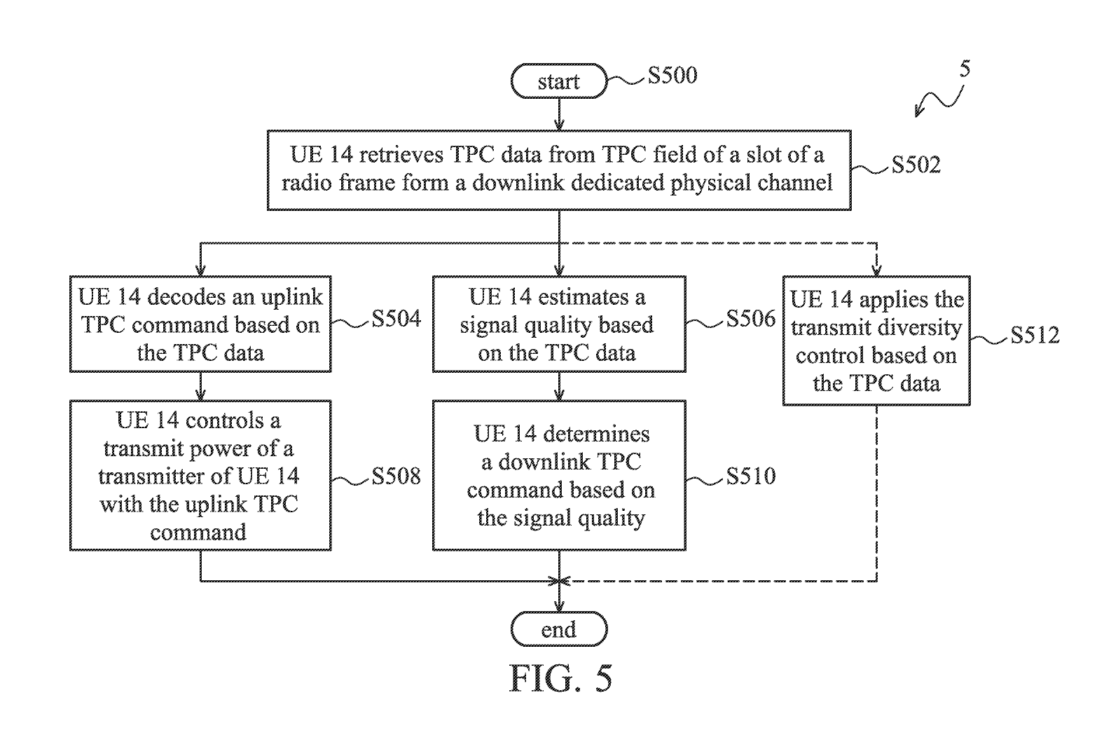

FIG. 5 is a flowchart of a power control method according to an embodiment of the invention.

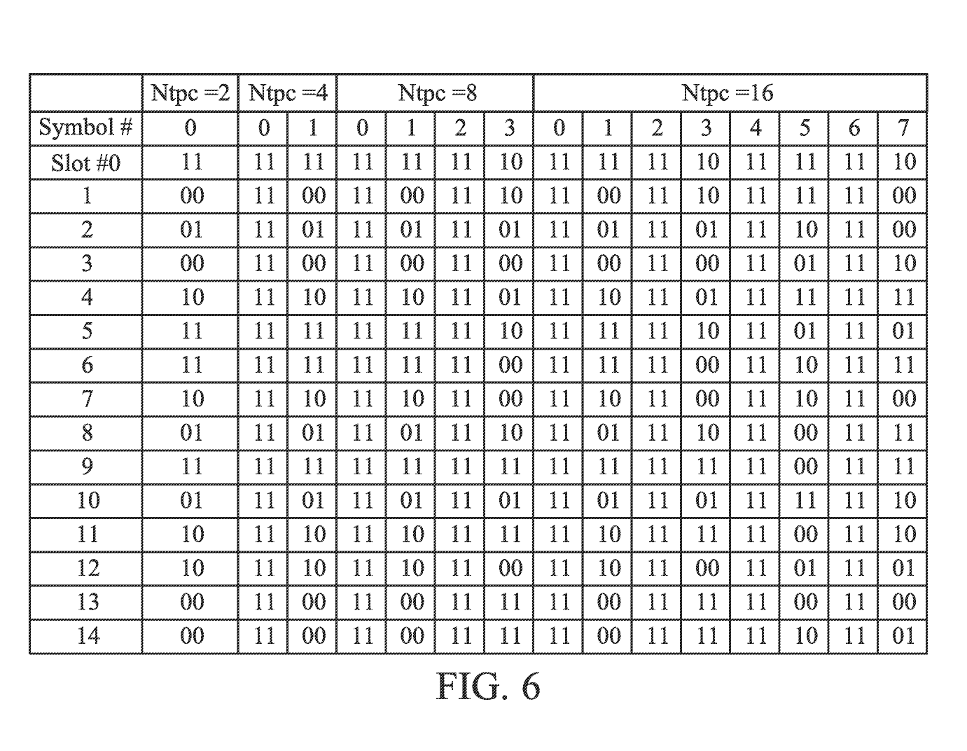

FIG. 6 is a table providing bit patterns for a TPC command indicating 1 in the TPC field of the slot according an embodiment of the invention.

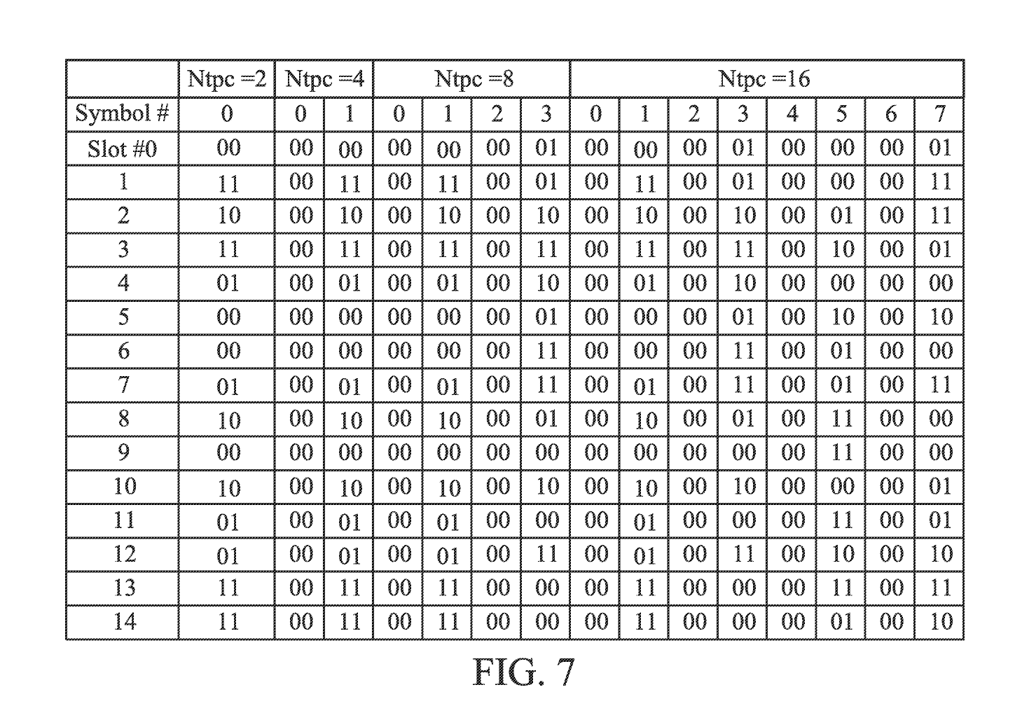

FIG. 7 is a table providing bit patterns for a TPC command indicating 0 in the TPC field of the slot according an embodiment of the invention.

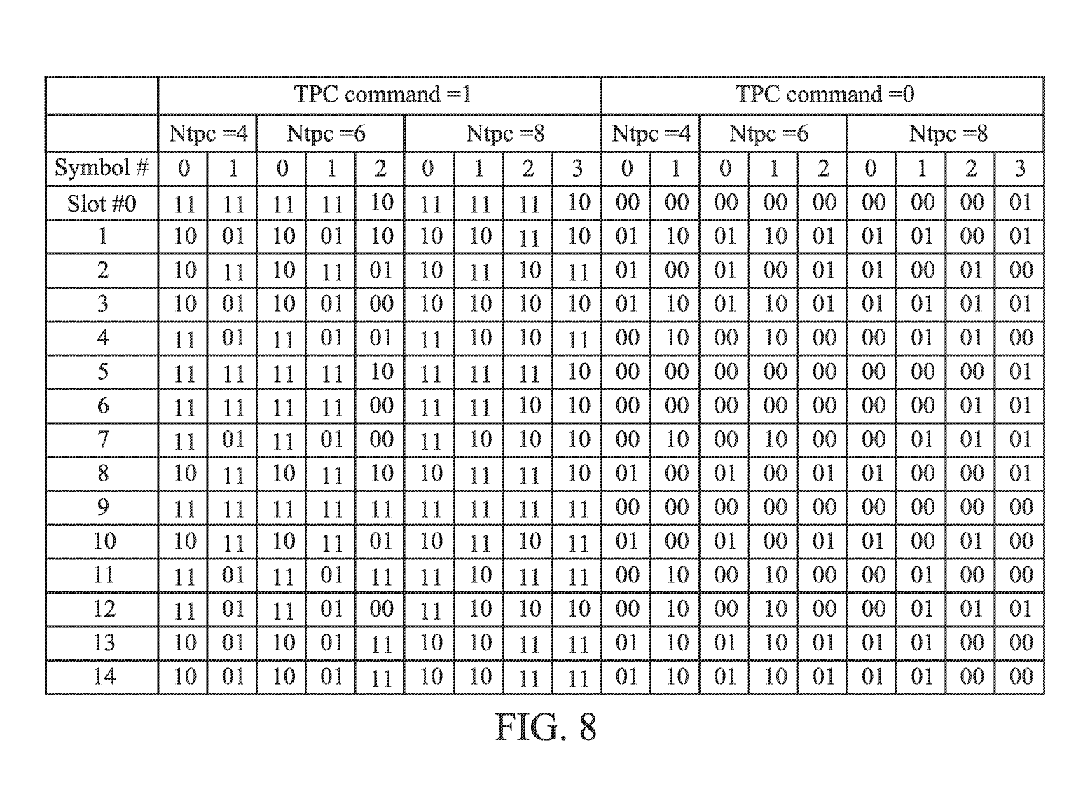

FIG. 8 is a table providing bit patterns for a TPC command in the TPC field of the slot according another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Since 1999, 3rd Generation Partnership Project (3GPP) relasesed several versions of spread-spectrum-based mobile communications system, including Universal Mobile Telecommunications Systems (UMTS), High-Speed Packet Access (HSPA), and High-Speed Packet Access+ (HSPA+). The following discussions are based on UMTS Frequency-Division Duplexing (FDD) communications system, which is also called Release 99 FDD to discriminate from those new features in later releases. We will illustrate various features and benefits of the disclosed power control methods, devices and systems.

FIG. 1 is a system diagram of a UTRAN 1 in a UMTS according to an embodiment of the invention, comprising a Node B 10 and a radio network controller (RNC) 12. A user equipment (UE) 14 can communicate with the Node B 10 by communications channels including an uplink dedicated physical channel (UL DPCH) and a downlink dedicated physical channel (DL DPCH). The UE 14 may be a notebook computer with a dongle, a mobile phone, or other mobile communications device capable of perform wireless communications with the Node B 10. The RNC 12 is connected to and controls a plurality of Node Bs. The UE 14 includes a transmitter (not shown), a receiver (not shown) and a controller (not shown).

Various embodiments in the invention address a downlink data slot format to be incorporated in a radio frame on the DL DPCH. The downlink data slot format contains no pilot field, but does contain a TPC field that may be placed at a middle section or a tail section of the downlink slot, as depicted by FIGS. 3A and 3B. The TPC data in the TPC field can be used to deploy the uplink and downlink transmit power control (TPC) and the transmit diversity control methods.

The UTRAN 1 employs a transmit power control (TPC) mechanism in both uplink and downlink directions, of which the former is referred to as uplink TPC and the later is referred to as downlink TPC.

To minimize the interference from other UEs, the uplink TPC tries to minimize the UL DPCH transmit powers observed at the Node B 10, while meeting specified target block error rates (BLER) for all links respectively. In the uplink TPC, the Node B 10 determines a TPC command based on signal quality of a received uplink slots on the UL DPCH and sends the TPC command by downlink slots on the DL DPCH, and the UE 14 receives the TPC command from the DL DPCH, which alters a gain of a transmitter of the UE 14 based on the received TPC command.

To minimize the interference to other UEs, the downlink TPC tries to minimize the DL DPCH transmit powers observed at the UE 14, while meeting specified target BLERs for all links respectively. In the downlink TPC, the UE 14 determines a TPC command based on signal quality of received downlink slots on the DL DPCH and sends the TPC command by uplink slots on the UL DPCH, and the Node B 10 receives the TPC command from uplink slots on the UL DPCH, and alters a gain of a transmitter on the Node B 10 based on the received TPC command

According to the foregoing discussion, the UE 14 uses the downlink slot on the DL DPCH to extract the TPC command for the uplink TPC, as well as to estimate the signal quality for the downlink TPC. The downlink slot disclosed in the invention contains a TPC data which can be used to decode the TPC command for the uplink TPC, as well as determine the TPC command for the downlink TPC. Details for the TPC method implemented by the downlink slot format disclosed in the embodiments are provided in the Steps S502-S508 in FIG. 5, in accompany with the exemplary downlink slot formats in FIGS. 3A, 3B, 4B and 4C.

In the embodiments, the UTRAN 1 can support two types of transmit diversity transmissions at the Node B 10 for user data performance enhancement, which are, open-loop and closed-loop transmit diversity methods.

The open-loop transmit diversity employs a space-time transmit diversity (STTD) technique which exploits diversity in both the spatial and temporal aspects in an open-loop fashion. The space-time coding used in UMTS FDD is space-time block codes. For example, the Node B 10 can send data in the radio frame by transmitting two signals that are orthogonal to each other over the air, allowing the receiver of the UE 14 to recover the data in the radio frame by a combination of the received two orthogonal signals.

In the case of the closed-loop transmit diversity, the Node B 10 uses two antennas to transmit the user information. The phases and amplitudes of the two antennas (not shown) may be adjusted based on the feedback command FBI from the UE 14, transmitted in the FBI field in the uplink DPCCH. The closed-loop transmit diversity itself has two modes of operation. In mode 1, the feedback commands FBI from the UE 14 control the phase adjustments that are expected to maximize the power received by the terminal The Node B 10 thus maintains the phase with one antenna and then adjusts the phase of another antenna based on the joint detection of the sliding two consecutive feedback commands. In mode 2, the amplitude may be adjusted in addition to the phase adjustment.

The downlink slot utilizes the TPC data for the transmit diversity. The UE 14 can apply the STTD decoding to the TPC data for implementing the open-loop transmit diversity. The UE 14 can incorporate a reference pilot on a common pilot channel (CPICH), in conjunction with the STTD decoded TPC data, to implement the closed-loop transmit diversity. Details for the transmit diversity implemented by the downlink slot format disclosed in the embodiments are described in the Step S512 in FIG. 5.

FIG. 2 shows a radio frame 2 on the DL DPCH, comprising 15 slots in a 10 ms radio frame, wherein each slot is 2560 chips in length, and contains time multiplexed control data on a dedicated physical control channel (DPCCH) and user data on a dedicated physical data channel (DPDCH). More specifically, each slot contains a Datal field 200, a Transmit Power Control (TPC) field 202, a Transport Format Combination Indicator (TFCI) field 204, a Data 2 field 206, and a Pilot field 208 in sequence. The Datal field 200 and the Data2 field 206 carry the user data on the DPDCH. The TPC field 202, TFCI field 204 and the pilot field 208 carry the control data on the DPCCH. The DPDCH is used to transport the dedicated transport channel (DCH) and the DPCCH is used to transport the physical control information necessary to maintain the layer 1 (i.e., physical layer) link.

The DPDCH is divided into parts, Datal field 200 and Data2 field 206.

The TPC field 202 contains TPC data that instructs the change of the transmit power of the transmitter at the UE 14. A number of bits N_{TPC} in the TPC field may be a value of either 2, 4, 8 or 16, depending on a spreading factor and whether a compressed mode is being applied. The spreading factor ranges from 4 to 512 to provide information on power control.

The TFCI field 204 is optional. When the TFCI field is present, a TFCI data in the TFCI field represent a transport formation combination used in the radio frame for de-rate matching and channel decoding. When the TFCI field is absent, the UE can determine a data type for the user data with Blind Transport Format Detection (BTFD) based on the positions of the error detection code and a transport formation combination (TFC) of the user data.

The Pilot field 208 contains pilot data provided to the DPCCH. The Pilot data is a bit pattern which defines frame synchronization and is used in the transmit power control and the transmit diversity control.

There are power offsets between the downlink DPCCH and the downlink DPDCH. Some of the power offsets, say PO3, are informed by the RRC (Radio Resource Control) connection setup message from the UTRAN 1 to the UE 14. The power offsets are fixed for all transport format combinations. The parameters PO1, PO2, and PO3 correspond to the power offsets for the TPC, TFCI and pilot fields 202, 204 and 208, respectively.

FIGS. 3A and 3B illustrate slot formats of a radio frame on the DL DPCH according to embodiments of the invention. Slot formats 3A and 3B shown in FIGS. 3A and 3B are not drawn to the scale, and merely display the order of each data field in sequence. FIG. 3A depicts the downlink slot format 3A which includes a Datal field 300a, a TPC field 302a, a TFCI field 304a and a Data2 field 306a. FIG. 3B depicts the downlink slot format 3B which includes a Datal field 300b, a TFCI field 302b and a Data2 field 304b and a TPC field 306b.

In comparison to the slot format specified by the 3GPP Release 99 specification, the slot formats 3A and 3B disclosed in the embodiments do not contain a pilot field. As a consequence, the data fields can occupy an increased data space in the slot formats 3A and 3B. Further, the TPC data in the TPC field 302a or 306b not only can be used to decode an uplink TPC command, but can also be used to determine a signal quality of the downlink signal and compute a downlink TPC command for the downlink TPC. Moreover, in some embodiments, the TPC data in the TPC field 302a or 306b can also be used for the open-loop or the closed-loop transmit diversity control, wherein detailed descriptions are provided in Step S512 of FIG. 5.

For the slot format 3A, the TPC field 302a is placed at a middle section of the slot, allowing an increased time for the UE 14 to estimate the signal qualities and determine the downlink TPC command, and a reduced time for the Node B 10 to decode the downlink TPC command and adjust the transmit power for the transmitter of the Node B 10. Consequently, the slot format 3A is favorable for the uplink TPC and unfavorable for the downlink TPC. For the slot format 3B, the TPC field 306b is placed at a tail section of the slot, resulting in a limited time for the UE 14 to decode the uplink TPC command and adjust the transmit power for the transmitter, and an increased time for the Node B 10 to determine the downlink TPC command for the downlink TPC. Thus, the slot format 3B is favorable for the downlink TPC and unfavorable for the uplink TPC.

FIG. 4A shows a power configuration for a slot of a radio frame on the DL DPCH, compliant with the 3GPP Release 99 specification. The DL DPCH slot 4A includes a Datal field 400a, a TPC field 402a, a TFCI field 404a, a Data2 field 406a and a Pilot field 408a. The UTRAN 1 assigns power offsets between the DPCCH and DPDCH by parameters PO1, PO2, and PO3, corresponding to power gains of the TPC field 402a, the TFCI field 404a and the Pilot field 408a of the DPCCH relative to that of the data fields Datal 400a and Data2 406a. The power offsets may vary in time.

As the pilot field has been omitted from the DL DPCH slot according to the embodiments of the invention, data space in the slot are made available for expanding TPC data size of the TPC field. Consequently, the power offset between the DPCCH and DPDCH may be decreased for the expanded TPC data size of the TPC field, while maintaining the substantially same level of the decoding error rate for the uplink TPC command, as depicted by FIGS. 4B and 4C. FIGS. 4B and 4C illustrate power configurations for slots of a radio frame on the DL DPCH according to embodiments of the invention. Slot formats 4B and 4C shown in FIGS. 4B and 4C are not drawn to scale, and merely display the order of each data field in sequence. The slot format 4B includes a Datal field 400b, a TPC field 402b, and a Data2 field 404b. The slot format 4C includes a Data field 400c and a TPC field 402c. The optional TFCI field is omitted in the slot formats 4B and 4C for simplicity, and those skilled in the art can recognize that the slot formats 4B and 4C may include the TFCI field without deviating from the principle of the invention.

For the slot format 4B, the TPC field 402b is placed at a middle section of the slot, and for the slot format 4C, the TPC field 402c is placed at a tail section of the slot. In both cases, the TPC data size of the TPC field may be increased to exceed the maximal data size set by the 3GPP Release 99 standard, or 16 bits. The TPC data carried by the TPC field 402b or 402c may contain two or more sets of a repeated data pattern. In some embodiments, the TPC data includes a data pattern that is directly repeated twice. In other embodiments, the TPC data includes a data pattern that is repeated every 2 bits. Further, the power offset for the TPC field 402b or 402c may be reduced to provide the substantially the same decoding error rate. The RNC 12 can calculate the power offset between the TPC field 402b or 402c and the data fields and informs the node B 10, which may adjust the power offset for the TPC field 402b or 402c by an RRC signaling. The power offset may vary in time, and may be carried by the RRC connection setup message from the UTRAN 1 to the UE 14. Since there is no Pilot field in the slot formats 4B and 4C, the power offset for the Pilot field is no longer required. In some embodiments, the power offset may be less than 6 dB, and even 0 dB. For the 0 dB power offset, the power levels of data fields 400b and 404b and the TPC field 402b or 402c are substantially the same. Consequently, the powers deposited at the DL DPCH at any instant will remain substantially constant and will not be varied by an excessive degree.

FIG. 5 is a flowchart of a power control method 5 according to an embodiment of the invention, incorporating the UTRAN 1 in FIG. 1.

Upon startup, the UE 14 is initialized to be ready to communicate with the Node B 10 on the uplink and downlink DPCHs (S500). The receiver of the UE 14 is configured to receive a radio frame from the downlink DPCH. The slot format of the slots of the radio frame may be the slot format 3A or slot format 3B as disclosed in FIG. 3A and FIG. 3B, without the presence of a pilot field. Subsequently, the controller of the UE 14 can be configured to retrieve the TPC data (first data) from the TPC field (S502). The controller of the UE 14 can decode the TPC data to determine an uplink TPC command (S504), and accordingly, adjust the transmit power or the amplification gain of the transmitter of the UE 14 by the uplink TPC command (S508). The uplink TPC command provides information on a direction or a sign which the UE 14 can adopt to adjust the transmit power with a fixed step size Δ_{TPC} dB. For example, the TPC data may contain a bit pattern representing the uplink TPC command, as depicted by Table 1 below, with a number of the bits N_{TPC} being 2, 4, or 8 bits. For example, when receiving the TPC data b′1111, the UE 14 can decode the uplink TPC command as 1 which represents an increased direction or a positive sign of the uplink TPC command, and accordingly, the UE 14 can increase the transmit power of the transmitter by the fixed step size Δ_{TPC} dB. When receiving the TPC data b′0000, the UE 14 can decode the uplink TPC command as 0 which represents a decreased direction or a negative sign of the uplink TPC command, and correspondingly, the UE 14 can decrease the transmit power of the transmitter by the fixed step size Δ_{TPC} dB.

TABLE 1

| TPC data | | | |
|---|---|---|---|
| N_{TPC} = 2 | N_{TPC} = 4 | N_{TPC} = 8 | uplink TPC command |
| 11 | 1111 | 11111111 | 1 |
| 00 | 0000 | 00000000 | 0 |

In some embodiments, the UE 14 can apply the pilot bit pattern for the downlink DPCH as the TPC data, as depicted by the tables in FIGS. 6 and 7. The TPC data may include a 2, 4, 8 or 16-bit pattern for each uplink TPC command, and the bit pattern for each slot is different from one another. FIG. 6 shows the table for the bit patterns of the uplink TPC command being 1, for slots 0 through 14 and the number of bits N_{TPC} of the bit patterns being 2, 4, 8 or 16. FIG. 7 shows the table for the bit patterns of the uplink TPC command being 0, for slots 0 through 14 and the number of bits N_{TPC} of the bit patterns being 2, 4, 8 or 16. For example, for the slot 2 and the number of bits N_{TPC} being 8, the uplink TPC command of 1 is represented by the TPC data b′11011101, for the slot 3 and the number of bits N_{TPC} being 8, the uplink TPC command of 0 is represented by the TPC data b′00110011.

In other embodiments, the UE 14 can apply the pilot bit pattern for the uplink DPCH as the TPC data, as depicted by the table in FIG. 8. In this case, the TPC data may include a 4, 6 or 8-bit pattern for each uplink TPC command, and the bit pattern for each slot is different from one another. FIG. 8 shows the table for the bit patterns of the uplink TPC commands 0 and 1 for slots 0 through 14 and the number of bits N_{TPC} of the bit patterns being 4, 6 or 8. For example, for the slot 2 and the number of bits N_{TPC} being 8, the uplink TPC command of 1 is represented by the TPC data b′10111011, and for the slot 3 and the number of bits N_{TPC} being 8, the uplink TPC command of 0 is represented by the TPC data b′01010101.

The TPC data size of the TPC field may be increased to exceed the maximal data size set by the 3GPP Release 99 standard, or 16 bits. The TPC data may contain two or more sets of a repeated data pattern. In some embodiments, the TPC data includes a data pattern that is directly repeated twice. In other embodiments, the TPC data includes a data pattern that is repeated every 2 bits.

After determining the sign or the direction of the uplink TPC command, the TPC data can further be used for estimating the signal quality (S506). The controller of the UE 14 can estimate the signal quality of the bit pattern of the TPC data by determining a signal-to-interference ratio (SIR), or other signal quality indications of the bit pattern. Next, the controller of the UE 14 can determine a downlink TPC command for the downlink transmit power control based on the estimated signal quality, and the transmitter of the UE 14 can transmit the determined downlink TPC command over the uplink DPCH to the Node B 10 (S510).

In some embodiments, the transmit diversity is implemented in the Node B 10, i.e., two transmit antennas are supported at the Node B 10 to transmit two different signals on the downlink DPCH. In response, the UE 14 can apply the STTD decoding for the open-loop or the closed-loop transmit diversity control to the TPC data (S512). In the case of the open-loop transmit diversity, the UE 14 is configured to perform the STTD decoding for every two symbols in each slot. Therefore in some cases, the TPC data will have to be STTD decoded with the user data in the DL DPDCH. In particularly, when N_{TPC}/2 is an odd number, the TPC data will have to be decoded with the user data.

In the case of the closed-loop transmit diversity, the receiver of the UE 14 is configured to receive a reference pilot data from a Common Pilot Channel (CPICH). In turn, the controller of the UE 14 is configured to perform the STTD decoding to the TPC data, and determine the feedback command FBI based on the STTD decoded data and the reference pilot data. The transmitter of the UE 14 is configured to transmit or report the FBI data back on the uplink DPCH to the Node B 10. Accordingly, the Node B 10 is configured to adjust the phase or amplitude of one of the antennas based on the FBI data. For the closed-loop transmit diversity, the number of the bits in the TPC field may be either 4, 8, or 16 bits. The transmit diversity control is optional and may be omitted in some embodiments.

When a compressed mode is implemented into the UE 14, the UE 14 can be disconnected from the Node B 10 temporarily and establish a connection to a second Node B (not shown) for taking a signal measurement. After the signal measurement is taken, the UE 14 can return to the Node B 10. In some embodiments, in the compressed mode, before the UE 14 returns to the Node B 10, a TPC data may be received on the downlink DPCCH by the receiver of the UE 14. The controller of the UE 14 can perform synchronization based on the bit pattern in the TPC field.

After the UE 14 completes the uplink TPC control in Steps S504 and S508, the downlink TPC control in Steps S506 and 510, and the transmit diversity control in Step S512, the power control method 5 is completed and exited.

By combining the functions of the TPC data and the Pilot data into the present TPC data in the embodiments, the data space required for the present TPC data is reduced, and the data spaced available to the user data on the downlink DPDCH is increased. As a consequence, the UE 14 can process the user data with a reduced coding rate, which further reduces consumed power required by the UE 14.

The power control method 5 utilizes a slot format on the downlink DPCH that eliminates the Pilot field and uses only the TPC data for the transmit power control and the transmit diversity control, reducing power offset between the DPCCH and the DPDCH by increasing data length of the TPC field, decreasing the coding rate of the user data by increasing available data space for the user data on DL DPDCH, and reducing required uplink transmit power and interference with or from the other UEs, thereby improving the system capacity.

As used herein, the term “determining” encompasses calculating, computing, processing, deriving, investigating, looking up (e.g., looking up in a table, a database or another data structure), ascertaining and the like. Also, “determining” may include resolving, selecting, choosing, establishing and the like.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller or state machine.

The operations and functions of the various logical blocks, modules, and circuits described herein may be implemented in circuit hardware or embedded software codes that can be accessed and executed by a processor.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method implemented by a mobile communications device, comprising:
retrieving a first data from a TPC field of a slot of a radio frame from a downlink dedicated physical channel (DL DPCH);
decoding an uplink TPC command based on the first data; and
estimating a signal quality based on the first data.

2. The method of claim 1, wherein the TPC field is at a tail section of the slot.

3. The method of claim 1, wherein the TPC field is at a middle section of the slot.

4. The method of claim 1, wherein a size of the first data exceeds 16 bits.

5. The method of claim 1, wherein the first data comprises a data pattern which is repeated every 2 data.

6. The method of claim 1, further comprising performing a Space-Time Transmit Diversity (STTD) decoding on the first data.

7. The method of claim 6, further comprising determining a feedback command based on the STTD decoded data and a reference signal from a Common Pilot Channel (CPICH), and transmitting the feedback command to perform a transmit diversity control on a base station.

8. The method of claim 1, wherein transmit powers for all data in the slot are substantially the same.

9. The method of claim 1, wherein the estimating step comprises estimating the signal quality based on the first data and a pilot pattern of the DL DPCH.

10. The method of claim 1, wherein the estimating step comprises
estimating the signal quality based on the first data and a pilot pattern of the uplink dedicated physical channel (UL DPCH).

11. A mobile communications device, comprising:
a receiver, configured to receive a radio frame from a DL DPCH;
a controller, coupled to the receiver, configured to retrieve a first data from a TPC field of a slot of the radio frame, decode an uplink TPC command based on the first data, and estimate a signal quality based on the first data.

12. The mobile communications device of claim 11, wherein the TPC field is at a tail section of the slot.

13. The mobile communications device of claim 11, wherein the TPC field is at a middle section of the slot.

14. The mobile communications device of claim 11, wherein a size of the first data exceeds 16 bits.

15. The mobile communications device of claim 11, wherein the first data comprises a data pattern which is repeated every 2 data.

16. The mobile communications device of claim 11, wherein the receiver is further configured to perform an STTD decoding on the first data.

17. The mobile communications device of claim 16, wherein:
the receiver is further configured to determine a feedback command based on the STTD decoded data and a reference signal from a CPICH; and
the mobile communications device further comprises a transmitter, coupled to the controller, configured to transmit the feedback command to perform a transmit diversity control on a base station.

18. The mobile communications device of claim 11, wherein powers for all data in the slot are substantially the same.

19. The mobile communications device of claim 11, wherein the controller is configured to estimate the signal quality based on the first data and a pilot pattern of the DL DPCH.

20. The mobile communications device of claim 11, wherein the controller is configured to estimate the signal quality based on the first data and a pilot pattern of a UL DPCH.
